(19) United States
(12) Patent Application Publication
(10) Pub. No.: US 2022/0337140 A1
(43) Pub. Date: Oct. 20, 2022

(54) STRIP-SHAPED WINDING UNIT FOR A STATOR WINDING AND METHOD FOR PRODUCING STRIP-SHAPED WINDING UNIT

(71) Applicant: Schaeffler Technologies AG & Co. KG, Herzogenaurach (DE)

(72) Inventors: Valentin Lehner, Karlsruhe (DE); Fabian Oehler, Wachenheim (DE)

(73) Assignee: Schaeffler Technologies AG & Co. KG, Herzogenaurach (DE)

(21) Appl. No.: 17/641,134

(22) PCT Filed: Aug. 25, 2020
(86) PCT No.: PCT/DE2020/100749

§ 371 Date: Mar. 8, 2022

(30) Foreign Application Priority Data
Sep. 9, 2019 (DE) 10 2019 124 162.6

(51) Int. Cl. H02K 15/04; H02K 15/00; H02K 3/12; H02K 3/28

(52) U.S. Cl. CPC H02K 15/0478; H02K 15/0037; H02K 3/12; H02K 3/28

(57) ABSTRACT

A strip-shaped winding unit for a stator winding has a first winding conductor, which is led in a plurality of layers of the winding unit and includes:
a. a plurality of straight groove portions which run in a transverse direction of the winding unit and are arranged mutually parallel;
b. a first curved end portion, which connects a first groove portion in the first layer to a second groove portion in a second layer adjacent to the first layer and is arranged on a first longitudinal side of the winding unit;
c. a second curved end portion, which connects the second groove portion in the second layer to a third groove portion in the first layer and is arranged on a second longitudinal side of the winding unit opposite the first longitudinal side;
d. a third curved end portion, which connects the third groove portion in the first layer with a fourth groove portion in the second layer and is arranged on the first longitudinal side of the winding unit; and
e. a fourth curved end portion, which connects the fourth groove portion in the second layer to a fifth groove portion in a third layer adjacent to the second layer and is arranged on the second longitudinal side of the winding unit.

### CROSS-REFERENCE TO RELATED APPLICATIONS

This application is the U.S. National Phase of PCT Appln. No. PCT/DE2020/100749 filed Aug. 25, 2020, which claims priority to DE 10 2019 124 162.6 filed Sep. 9, 2019, the entire disclosures of which are incorporated by reference herein.

### TECHNICAL FIELD

The disclosure relates to a strip-shaped winding unit for a stator winding, comprising a first winding conductor, which is led in a plurality of layers of the winding unit. The disclosure further comprises a method for producing such a strip-shaped winding unit.

### BACKGROUND

In the production of a stator winding in the manner of a wave winding, individual strands of enameled wire are typically pre-bent around a winding former in order to produce a strip-shaped winding unit which can be introduced into the grooves of a stator core as part of the stator winding. The winding former is usually designed as a thin blade, along which a plurality of winding conductors are simultaneously bent with movable wire clamps in the sense of the winding shape.

To produce a two-layer strip-shaped winding unit, it is known, for example from US 2018/0 331 606 A1, after each bending step in which the winding conductors are bent, to rotate the winding former in the same direction around its own axis in order to obtain a strip-shaped winding unit wound around the winding former. The mat-like winding unit created in this manner is optionally rolled up onto a support tool together with other such winding units and then inserted into the stator core of the electric motor, wherein the winding conductors are introduced into grooves in the stator core.

Depending on the number of phases of the electric motor, the individual winding units are then connected to the individual phases, to the star point and/or to one another. The wiring sequence, the number of winding conductors and winding units are dependent on the design of the respective electric motor.

When using the known strip-shaped winding unit, an uneven distribution of the winding conductors of the individual phases is produced within the grooves of the stator core in the region of the connections of the winding units. This results in an asymmetrical magnetic behavior of the stator. The efficiency of the entire electric motor is thereby degraded. In addition, when inserting the winding unit into the stator core, it is necessary to deform the winding conductors with a support tool in order to achieve the positioning of the winding conductors at the correct locations within the grooves of the stator core. This means that higher press-in forces must be generated during joining in order to achieve the deformation of the wires. This increases the wire tensions and can damage the wire insulation. This can lead to short circuits, which further degrade the efficiency of the motor or can damage the motor.

### SUMMARY

Against this background, the object is to enable an electric motor with high efficiency.

The object is achieved by a strip-shaped winding unit for a stator winding, comprising a first winding conductor, which is led in a plurality of layers of the winding unit and comprises:

a plurality of straight groove portions which run in a transverse direction of the winding unit and are arranged mutually parallel,

a first curved end portion, which connects a first groove portion in the first layer to a second groove portion in a second layer adjacent to the first layer and is arranged on a first longitudinal side of the winding unit,

a second curved end portion, which connects the second groove portion in the second layer to a third groove portion in the first layer and is arranged on a second longitudinal side of the winding unit opposite the first longitudinal side,

a third curved end portion, which connects the third groove portion in the first layer to a fourth groove portion in the second layer and is arranged on the first longitudinal side of the winding unit and

a fourth curved end portion, which connects the fourth groove portion in the second layer to a fifth groove portion in a third layer adjacent to the second layer and is arranged on the second longitudinal side of the winding unit.

In contrast to the background of the art, the winding former is not always rotated in the same direction of rotation during the production of the strip-shaped winding unit according to the disclosure. Rather, the winding former is rotated in a first direction of rotation to form the first, second and third end portions and rotated in a second direction of rotation opposite to the first direction of rotation to form the fourth curved end portion. As a result, in contrast to the background of the art, the winding conductor runs not only in a first and a second layer, but also at least in a third layer. It has been shown that the strip-shaped winding unit according to the disclosure can be used to produce a stator winding which also has a symmetrical groove distribution in the transition region of the layers, and thus leads to an increase in the efficiency of the electric motor. In addition, the course of the winding conductor is already pre-bent by the change into the third layer as it ultimately also runs in the stator, as a result of which the press-in forces when inserting the strip-shaped winding unit into the stator core can be reduced.

According to an advantageous embodiment of the disclosure, it is provided that the strip-shaped winding unit comprises a fifth curved end portion, which connects the fifth groove portion in the third layer to a sixth groove portion in a fourth layer adjacent to the third layer and is arranged on the first longitudinal side of the winding unit. To form the fifth curved end portion, the winding former can be rotated in its first, original direction of rotation.

A preferred embodiment of the disclosure provides that the strip-shaped winding unit comprises a sixth curved end portion, which connects the sixth groove portion in the fourth layer to a seventh groove portion in the third layer and is arranged on the second longitudinal side of the winding unit. To form the sixth curved end portion, the winding former can be rotated in its first, original direction of rotation.

It is preferably provided that the strip-shaped winding unit comprises one or more second winding conductors, which are identical in design to the first winding conductor and are arranged offset in such a way that the first and the second winding conductors are arranged in the same plurality of layers of the winding unit. In particular, the first and second winding conductors have straight groove portions running in a transverse direction of the winding unit, which are each arranged running mutually parallel.

The disclosure also relates to a method for producing a strip-shaped winding unit for a stator winding, comprising a first winding conductor, which is led in a plurality of layers of the winding unit, having the following method steps:

providing a plurality of straight groove portions which run in a transverse direction of the winding unit and are arranged mutually parallel,

providing a first curved end portion, which connects a first groove portion in the first layer to a second groove portion in a second layer adjacent to the first layer and is arranged on a first longitudinal side of the winding unit,

providing a second curved end portion, which connects the second groove portion in the second layer to a third groove portion in the first layer and is arranged on a second longitudinal side of the winding unit opposite the first longitudinal side,

providing a third curved end portion, which connects the third groove portion in the first layer to a fourth groove portion in the second layer and is arranged on the first longitudinal side of the winding unit,

providing a fourth curved end portion, which connects the fourth groove portion in the second layer to a fifth groove portion in a third layer adjacent to the second layer and is arranged on the second longitudinal side of the winding unit.

The same advantages can be achieved with the production method as have already been described in connection with the strip-shaped winding unit according to the disclosure.

An advantageous embodiment of the method provides that the first winding conductor is bent around a first winding former, in particular a first blade former, in order to provide the first, second and third curved winding portions. During the bending to provide the first, second and third curved winding portions, the first winding former is preferably rotated in the same first direction of rotation about a first axis of rotation, in particular a longitudinal axis of the first winding former.

According to an advantageous embodiment, in order to provide the fourth curved end portion, the winding conductor is bent around a second winding former, in particular a second blade former. The second winding former can be placed against the first winding former. It is preferred if the second winding former is rotated about a second axis of rotation in a second direction of rotation, opposite the first direction of rotation, in order to provide the fourth curved end portion. The second axis of rotation is preferably parallel to the first axis of rotation and/or is a longitudinal axis of the second winding former.

In this context, it is advantageous if the second winding former is first placed against the first winding former and then the first winding former and the second winding former are rotated, in particular simultaneously, in order to provide the fourth curved end portion. It is preferred if the first winding former and the second winding former are rotated about the second axis of rotation in a second direction of rotation, opposite the first direction of rotation, in order to provide the fourth curved end portion. The second axis of rotation is preferably parallel to the first axis of rotation and/or is a longitudinal axis of the second winding former.

According to an advantageous embodiment, it is provided that the first winding conductor is bent around a third winding former, in particular a third blade former, in order to provide a fifth curved end portion. Due to the offset that results from the course in a third layer, it is necessary to continue on the third winding former for the further production of the strip-shaped winding unit. In order to provide the fifth curved end portion, the third winding former is preferably rotated in the first direction of rotation about a third axis of rotation, which corresponds to the direction of rotation of the first winding former for bending the first, second and third end portions. The third axis of rotation is preferably parallel to the first axis of rotation and/or the second axis of rotation and/or is a longitudinal axis of the third winding former.

It is advantageous if the first winding conductor is bent around the third winding former in order to provide a sixth curved end portion. In order to provide the sixth curved end portion, the third winding former is preferably rotated about the third axis of rotation in the first direction of rotation.

As an alternative or in addition to the advantageous embodiments described above, the preferred configurations and optional features discussed in connection with the strip-shaped winding unit can also be applied alone or in combination regarding the method.

### BRIEF DESCRIPTION OF THE DRAWINGS

Further details and advantages of the disclosure will be explained below with reference to the exemplary embodiment shown in the drawings. In the figures:

FIG. 1 shows a side view of an exemplary embodiment of a strip-shaped winding unit according to the disclosure;

FIG. 2 shows the strip-shaped winding unit according to FIG. 1 in a plan view;

FIG. 3 shows a stator winding with a strip-shaped winding unit according to an exemplary embodiment of the disclosure in a schematic plan view;

FIG. 4 shows the stator winding according to FIG. 3 in a perspective view;

FIG. 5 shows a detail of the stator winding from FIG. 4 in a plan view;
and

FIG. 6 shows a detail of the stator winding from FIG. 4 in a view from below.

### DETAILED DESCRIPTION

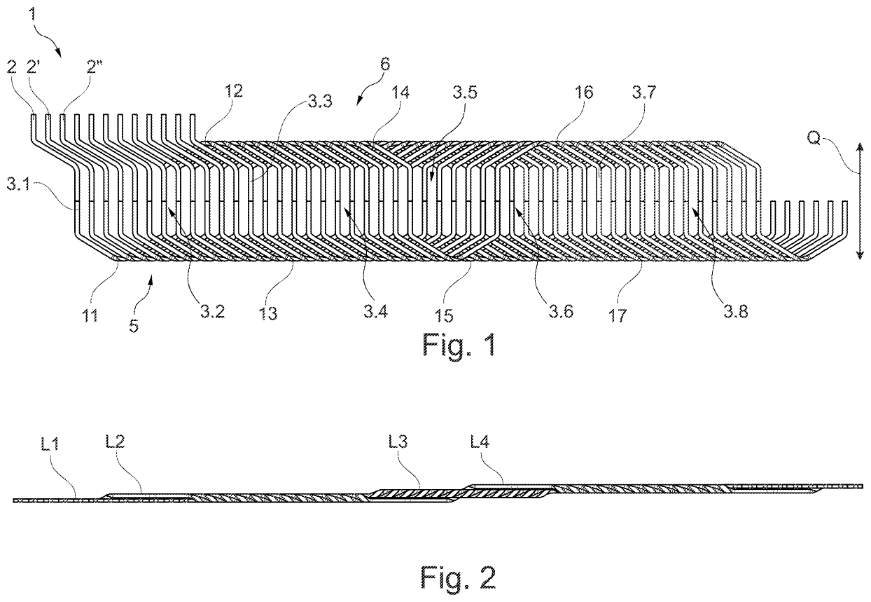

FIGS. 1 and 2 show an exemplary embodiment of a strip-shaped winding unit 1 according to the disclosure, which is designed in the shape of a strip. The winding unit 1 comprises a plurality of winding conductors 2, 2′, which are led in a plurality of layers L1, L2, L2, L4, in this case exactly four, of the winding unit 1. The winding conductors 2, 2 ‘ are identical in design and are arranged offset from one another in such a way that all the winding conductors 2, 2’ pass through the same layers L1, L2, L3, L4 of the winding unit 1. Both winding conductors 2, 2′ comprise a plurality of straight groove portions 3.1-3.8 which run in a transverse direction Q of the winding unit 1 and are arranged mutually parallel. The distance between the groove portions 3.1-3.8 is dimensioned such that adjacent groove portions 3.1-3.7 can be introduced into different stator grooves of a stator core of an electric motor. The groove portions 3.1-3.8 are interconnected via end portions 11-17 which, in a state in which the groove portions 3.1-3.8 of the winding unit 1 are introduced into the stator grooves of a stator core, protrude from the end face of the stator core and form an end winding.

The course of a first winding conductor 2 starting from a first connection shown on the left in FIGS. 1 and 2 in the first length L1 to a second connection shown on the right in the fourth layer L4 will be described below. This description applies to the other winding conductors 2′ in a corresponding manner. A first curved end portion 11 of a first winding conductor 2 connects a first groove portion 3.1 in the first layer L1 to a second groove portion 3.2 in a second layer L2 adjacent to the first layer L1. This first curved end portion 11 is arranged on a first longitudinal side 5 of the winding unit 1, which is shown at the bottom in FIG. 1 and is located opposite the first connection. A second curved end portion 12 connects the second groove portion 3.2 in the second layer L2 to a third groove portion 3.3 in the first layer L1. This second curved end portion is arranged on a second longitudinal side 6 of the winding unit 1 opposite the first longitudinal side 5. A third curved end portion 13 connects the third groove portion 3.3 in the first layer L1 to a fourth groove portion 3.4 in the second layer L2. This third curved end portion 13 is arranged on the first longitudinal side 5 of the winding unit 1.

To form the first, second and third curved end portion 11, 12, 13 of the winding conductor 2, the latter is bent around a first winding former, which is designed in the manner of a flat blade former. When the first, second and third curved end portions 11, 12, 13 are bent, this winding former is rotated in the same first direction of rotation about a longitudinal axis of the first winding former.

The strip-shaped winding unit also comprises a fourth curved end portion 14, which connects the fourth groove portion 3.4 in the second layer L2 to a fifth groove portion 3.5 in a third layer L3 adjacent to the second layer L2 and is arranged on the second longitudinal side 6 of the winding unit 1. To form this fourth curved end portion 14, the winding conductor is bent around a second winding former which is placed against the first winding former. The second winding former is also designed as a blade former, preferably as a blade former that is identical to the first winding former. In contrast to the first winding former, the second winding former is used to form the fourth curved end portion 14 in a second direction of rotation, opposite the first direction of rotation, about a longitudinal axis of the second winding former, which is arranged parallel to the first axis of rotation. The first winding former is preferably also rotated about its longitudinal axis in the second direction of rotation. This change of folding or bending direction forms another layer of the winding unit 1, here the third layer L3. Therefore, a step-like offset is produced in the strip-shaped winding unit 1.

The winding unit 1 according to the exemplary embodiment also comprises a fifth curved end portion 15, which connects the fifth groove portion 3.5 in the third layer L3 to a sixth groove portion 3.6 in a fourth layer L4 adjacent to the third layer L3 and is arranged on the first longitudinal side 5 of the winding unit 1. To form this fifth curved end portion 15, the winding conductor 2 is bent around a third winding former. This is also designed as a blade former, which is preferably identical to the first winding former. In order to bend the winding conductor 2 in the region of the fifth curved end portion 15, the winding former is rotated in the first direction of rotation about a longitudinal axis of the third winding former. The sixth curved end portion 16 connects the sixth groove portion 3.6 in the fourth layer L4 to a seventh groove portion 3.7 in the third layer L3 and is arranged on the second longitudinal side 6 of the winding unit 1. To form the sixth curved end portion 16, the winding conductor is again bent around the third winding former, wherein this is rotated in the first direction of rotation.

Ultimately, what is obtained is a strip-shaped winding unit 1 that has a plurality of steps—that is, layer changes. According to a deviation from the exemplary embodiment, the winding conductors 2, 2′ of the strip-shaped winding unit can have further groove portions and end portions and can extend in further layers. For example, a winding unit can have a multiple of the length of the winding unit 1 shown in the exemplary embodiment. A strip-shaped winding unit according to such a modification of the exemplary embodiment can comprise, for example, two or more winding units 1 according to the exemplary embodiment, which are connected in series. In this way, a strip-shaped winding unit can be obtained which is adapted to a number of grooves in the stator core (laminated core) that differs from the exemplary embodiment.

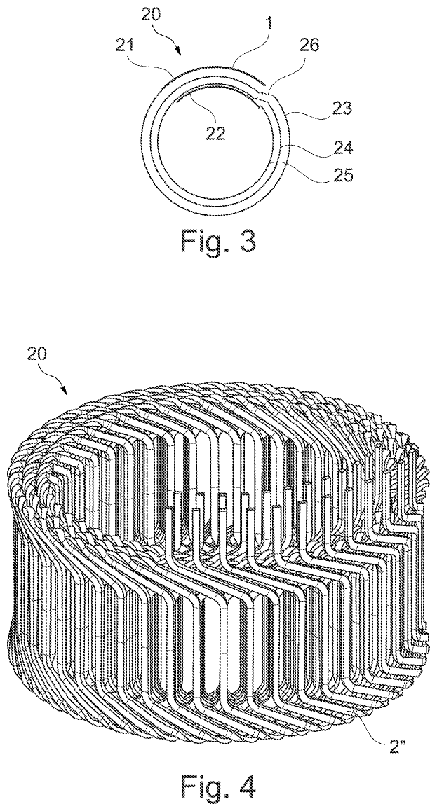

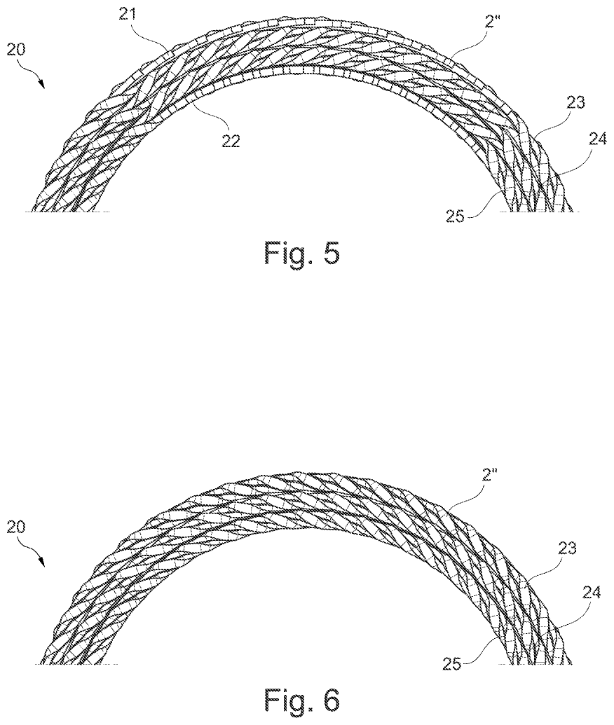

The illustrations in FIGS. 3 to 6 show a spiral arrangement of the strip-shaped winding unit as a stator winding 20 in the manner of a wave winding of a stator of an electric motor. The stator core (the laminated core) of the stator is not shown, to allow for better visibility of the stator winding. As the schematic plan view in FIG. 3 makes clear, the strip-shaped winding unit 1 according to this exemplary embodiment is arranged in such a way that, starting from the first connections (starting connections) 21 towards the second connections (end connections) 22, it forms three circuits 24, 25, 26, so that a three-layer stator winding 20 is the result. After each complete circuit 23, 24, 25, the spirally arranged strip-shaped winding unit 1 jumps in a transition region 26.

In the case of a stator winding with a conventional strip-shaped winding unit, it is necessary to deform the winding unit, in particular the winding conductors in the transition region, by pressing in when inserting the winding mat into the stator core. The deformation takes place both on the upper end winding and on the lower end winding and can lead to stresses in the winding conductor and damage to its insulation. Such consequences are avoided with the strip-shaped winding unit 1 according to the disclosure. As can be seen in FIG. 4, in the case of the stator winding 20 formed with the strip-shaped winding unit 1 according to the disclosure, a uniformly alternating distribution of the winding conductor over the grooves of the stator core is produced. The course of a winding conductor 2″ is highlighted here. A gradation is achieved in the transition region 26. This gradation already follows the final course of the wire in the stator before the strip-shaped winding unit 1 is introduced into the stator core, as a result of which the press-in forces are reduced since the wire does not have to be deformed when it is inserted into the stator core.

The strip-shaped winding unit 1 according to the disclosure avoids an asymmetry in the grooves in the region of the start of the stator winding 20, resulting in improved magnetic behavior of the electric motor, i.e. an increase in efficiency. Furthermore, only lower press-in forces are required when inserting the stator winding 20 into the stator core, since there is no deformation of the wires in the region of the transitions. In addition, a reduction in wire tensions and a lower risk of insulation damage is achieved. Finally, the wire runs more uniformly in the end winding, so that the winding can be displayed and parameterized in the 3D model in a less complex manner. In this manner, a higher accuracy of the model and a reduction in complexity can be achieved.

### LIST OF REFERENCE SYMBOLS

1 Strip-shaped winding unit
2, 2′, 2″ Winding conductor
3.1-3.8 Groove portion
5 Longitudinal side
6 Longitudinal side
11-17 Curved end portion
20 Stator winding
21 Connections
22 Connections
23 Circuit
24 Circuit
25 Circuit
26 Transition region
L1-L4 Layer
Q Transverse direction

1. A strip-shaped winding unit for a stator winding, comprising: a first winding conductor, which is led in a plurality of layers of the winding unit and comprises:
a. a plurality of straight groove portions, which run in a transverse direction of the winding unit and are arranged mutually parallel,
b. a first curved end portion, which connects a first groove portion in a first layer of the plurality of layers to a second groove portion in a second layer of the plurality of layers adjacent to the first layer and is arranged on a first longitudinal side of the winding unit,
c. a second curved end portion, which connects the second groove portion in the second layer with a third groove portion in the first layer and is arranged on a second longitudinal side of the winding unit opposite the first longitudinal side,
d. a third curved end portion, which connects the third groove portion in the first layer to a fourth groove portion in the second layer (L2) and is arranged on the first longitudinal side of the winding unit, and
e. a fourth curved end portion, which connects the fourth groove portion in the second layer to a fifth groove portion in a third layer of the plurality of layers adjacent to the second layer and is arranged on the second longitudinal side of the winding unit.

2. The strip-shaped winding unit according to claim 1, wherein a fifth curved end portion, which connects a fifth groove portion in the third layer to a sixth groove portion in a fourth layer of the plurality of layers adjacent to the third layer and is arranged on the first longitudinal side of the winding unit.

3. The strip-shaped winding unit according to claim 2, wherein a sixth curved end portion, which connects the sixth groove portion in the fourth layer to a seventh groove portion in the third layer and is arranged on the second longitudinal side of the winding unit.

4. The strip-shaped winding unit according to claim 1, wherein one or more second winding conductors which are identical in design to the first winding conductor and are arranged offset in such a way that the first and the second winding conductors are arranged in the same plurality of layers of the winding unit.

5. A method for producing a strip-shaped winding unit for a stator winding, having a first winding conductor, which is led in a plurality of layers of the winding unit, the following method steps:
a. providing a plurality of straight groove portions, which run in a transverse direction of the winding unit and are arranged mutually parallel,
b. providing a first curved end portion, which connects a first groove portion in a first layer of the plurality of layers to a second groove portion in a second layer of the plurality of layers adjacent to the first layer and is arranged on a first longitudinal side of the winding unit,
c. providing a second curved end portion, which connects the second groove portion in the second layer to a third groove portion in the first layer and is arranged on a second longitudinal side of the winding unit opposite the first longitudinal side,
d. providing a third curved end portion, which connects the third groove portion in the first layer to a fourth groove portion in the second layer and is arranged on the first longitudinal side of the winding unit,
wherein
e. providing a fourth curved end portion, which connects the fourth groove portion in the second layer to a fifth groove portion in a third layer of the plurality of layers adjacent to the second layer and is arranged on the second longitudinal side of the winding unit.

6. The method according to claim 5, wherein the first winding conductor is bent around a first winding former in order to provide the first, second and third curved end portions.

7. The method according to claim 6, wherein the winding conductor is bent around a second winding former in order to provide the fourth curved end portion.

8. The method according to claim 7, wherein the second winding former is first placed against the first winding former and then the first winding former and the second winding former are rotated in order to provide the fourth curved end portion.

9. The method according to claim 8, wherein the first winding conductor is bent around a third winding former in order to provide a fifth curved end portion.

10. The method according to claim 9, wherein the first winding conductor is bent around the third winding former in order to provide a sixth curved end portion.

11. The method according to claim 6, wherein the first winding former is a first blade former.

12. The method according to claim 7, wherein the second winding former is a second blade former.

13. The method according to claim 8, wherein the first winding former and the second winding former are rotated simultaneously.

14. The method according to claim 9, wherein the third winding former is a third blade former.
